(19) United States
(12) Patent Application Publication
(10) Pub. No.: US 2005/0234565 A1
(43) Pub. Date: Oct. 20, 2005

(54) Programmable control system for automated actuator operation

(75) Inventors: Paul W. Marks, West Sussex (GB); Michael A. Ferris, Vista, CA (US); Stephen E. Curtiss, Lowell, MI (US); Willie T. Clark, Fremont, CA (US); Steve J. Haidos, St. Paul, MN (US); Edward A. Neff, Rancho Santa Fe, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Systems, Machines, Automation Components, Corporation, Carlsbad, CA (US)

(21) Appl. No.: 11/097,521

(22) Filed: Apr. 1, 2005

Related U.S. Application Data
(60) Provisional application No. 60/558,979, filed on Apr. 1, 2004.

(51) Int. Cl. G05B 15/00; G05B 19/18

(52) U.S. Cl. 700/61; 700/83

(57) ABSTRACT

A programmable control system and related features and methods are provided for the operation an automated, actuator-based component inspection system. In one implementation, the invention can be characterized as an actuator control system comprising: a controller adapted to be coupled to and control an actuator including a probe moveable by the actuator about an axis in response to control signals from the controller; a user input device coupled to the controller and configured to receive inputs from a user to define an automated sequence of multiple locations of the probe and configured to cause an encoder measurement to be retrieved from the actuator; and the user input device further configured to receive a tolerance value from the user corresponding to the encoder measurement.

This application claims the benefit of U.S. Provisional Application No. 60/558,979, filed Apr. 1, 2004, which is incorporated herein by reference

### BACKGROUND OF THE INVENTION

1. Field of the Invention

The present invention relates generally to control systems for actuator devices, and more specifically to programmable control systems for actuator based inspection systems.

2. Discussion of the Related Art

Quality control is important in the manufacture of components in an assembly process. Often, components are manufactured with precise dimensions and have tight critical tolerance requirements. Machines such as actuators may be used to inspect, measure and determine if one or more critical dimensions of the component are within tolerance. For example, the probe of a moving coil actuator may be used to precisely measure a dimension of interest, the measurement then used to determine if the dimension is within a tolerance window. Typically, a servo controller is coupled to the actuator and programmed with software specifically written to operate the actuator in a manner to obtain the desired measurements for a given component to be inspected.

### SUMMARY OF THE INVENTION

Several embodiments of the invention provide a programmable control system to operate an automated, actuator-based component inspection system. In one form, programming instructions are developed to operate the control system and to allow a user to program an inspection routine for a specific component including input tolerances.

In one embodiment, the invention can be characterized as an actuator control system comprising: a controller adapted to be coupled to and control an actuator including a probe moveable by the actuator about an axis in response to control signals from the controller; a user input device coupled to the controller and configured to receive inputs from a user to define an automated sequence of multiple locations of the probe and configured to cause an encoder measurement to be retrieved from the actuator; and the user input device further configured to receive a tolerance value from the user corresponding to the encoder measurement.

In another embodiment, the invention can be characterized as a method of programming an actuator controller for an automated inspection system comprising the steps of: receiving user inputs from a user interface, the inputs defining sequential positions of an actuator probe of an actuator about an axis relative to a component to be inspected and causing an encoder measurement to be retrieved from the actuator; storing a motion profile based on the user inputs; receiving a tolerance value from the user interface, the tolerance value associated with the encoder measurement; and storing the tolerance value as a part of the motion profile.

In a further embodiment, the invention may be characterized as a program for an automated actuator based inspection system comprising: a memory; and a set of program instructions executable by a processor stored on the memory, the set of program instructions configured to: receive inputs from a user interface, the inputs defining sequential positions of an actuator probe of an actuator about an axis relative to a component to be inspected and causing an encoder measurement to be retrieved from the actuator; store a motion profile based on the inputs; receive a tolerance value from the user interface, the tolerance value associated with the encoder measurement; and store the tolerance value as a part of the motion profile.

In yet another embodiment, the invention may be characterized as a control program for an actuator-based inspection system comprising: a memory; a motion profile stored in the memory, the motion profile including parameters defining sequential locations of a probe about at least one axis of an actuator relative to a component to be inspected, the motion profile including parameters defining encoder measurements to be retrieved from the actuator, and the motion profile including parameters defining a tolerance value corresponding to at least one encoder measurement; and a set of program instructions executable by a processor stored on the memory. The set of program instructions is configured to: control positional locations of the probe about the at least one axis of the actuator relative to the component to be inspected in accordance with the motion profile; cause the at least one encoder measurement to be retrieved from the actuator in accordance with the motion profile; determine if the at least one encoder measurement is within the tolerance value; wherein the set of program instructions is and unable to execute an inspection routine for the component to be inspected without access to the motion profile.

In another embodiment, the invention may be characterized as a method for use in an actuator control system comprising the steps of: receiving a request to copy a motion profile stored in a first memory in a first device to a second memory of a second device, the motion profile including parameters defining sequential locations of a probe of an actuator about at least one axis of the actuator relative to a component to be inspected by the actuator control system and including parameters defining encoder measurements to be retrieved from the actuator, wherein the motion profile is to be used in cooperation with a set of program instructions adapted to operate the actuator in accordance with the motion profile; saving a copy of the motion profile to the second memory of the second device.

In yet another embodiment, the invention may be characterized as a method for use in an actuator control system comprising the steps of: receiving a request to copy a set of program instructions stored in a first memory in a first device to a second memory of a second device, the set of program instructions specific to a type of an actuator and wherein the set of program instructions is configured to be used in cooperation with a motion profile including parameters defining sequential locations of a probe of the actuator about at least one axis of the actuator relative to a component to be inspected by the actuator control system and including parameters defining encoder measurements to be retrieved from the actuator; and saving a copy of the set of program instructions to the second memory of the second device.

### BRIEF DESCRIPTION OF THE DRAWINGS

The above and other aspects, features and advantages of the present invention will be more apparent from the following more particular description thereof, presented in conjunction with the following drawings.

FIG. 1 is a system block diagram of a programmable and automated, actuator-based component inspection system according to several embodiments of the invention.

FIG. 2 is a hardware block diagram of a control system implemented for example in the controller of FIG. 1, where program instructions are stored in memory and executed by a processor according to one embodiment of the invention.

FIG. 3 is a hardware block diagram of a user input device for use in combination with the controller of FIGS. 1-2 in accordance with one embodiment of the invention.

FIG. 4 is one embodiment of a flowchart of the functionality of the program instructions for the programmable and automated control system of the actuator-based inspection system of FIG. 1.

FIG. 5 is one embodiment of an input device that allows a user to program an automated inspection and measurement routine and input tolerances.

FIG. 6 is an alternative embodiment of an input device that allows a user to program an automated inspection and measurement routine and input tolerances.

FIG. 7 is a diagram illustrating a portion of memory that is configured to store a motion profile taught by a user in accordance with one embodiment of the invention.

FIG. 8 is a flowchart of the steps performed in a method of programming an actuator-based automated inspection routine with tolerance windows.

FIG. 9 is a diagram of a portion of an actuator-based inspection system for gauging/inspecting a component.

FIG. 10 is a flowchart of the steps performed in accordance with one embodiment of the invention.

FIG. 11 is a flowchart of the steps performed in accordance with one embodiment of the invention.

FIG. 12 is a sample motion profile according to one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of the preferred embodiments. The scope of the invention should be determined with reference to the claims.

It is an object of several embodiments to provide a programmable control system to operate an automated, actuator-based component inspection system. Programming instructions, implemented as software and/or firmware, are provided to operate the control system and include a user interface to allow a user to program an inspection routine (e.g., define an actuator motion profile) for a specific component including input tolerances. Advantageously, the design of this control system eliminates the need to write programming instructions that are specific to a specific application. In other words, the control system programming instructions is written to allow for an operator to configure the inspection system for any component to be inspected without rewriting or altering the actual instructions or code of the control system. Additionally, in preferred embodiments, the programming instructions allow a user to program or define multiple motion profiles, each motion profile specific to a particular component.

It is an object of several embodiments to provide a user interface that allows a user to program or teach an actuator-based automated inspection system an automated actuator routine, as well as input any desired tolerances.

It is an object of several embodiments to provide a control system that automatically executes a user programmed routine and outputs pass/fail results based on actual measurements, reference measurements and user input tolerances.

It is an object of several embodiments to provide a user interface that allows a user to program or teach an actuator-based automated inspection system an automated actuator routine or motion profile as the inspection system is in use.

In preferred embodiments, a probe of the actuator of an actuator-based automated inspection system is controllable about at least one actuation axes, for example, including but not limited to, x, y, z and/or rotation axes, as well as being able to read positional and/or force measurements of the probe about one or more of the actuation axes.

In other embodiments, a user input device stores one or more motion profiles that are each specific to a particular component, while also allowing these stored motion profile/s to be transferred or downloaded into different controller devices that operate separate actuators.

In preferred embodiments, the actuator/s of the actuator based automated inspection system comprise voice coil or moving coil actuators.

Referring first to FIG. 1, a system block diagram is shown of a programmable and automated, actuator-based component inspection system according to several embodiments of the invention. The system 100 includes an actuator 102, a controller 104, an input device 106 and a master controller 108. Also shown is a component 110 to be inspected, the component positioned by a handler 112.

The actuator 102 may be any actuator based device, such as a pneumatic, hydraulic or electrical actuator. In preferred embodiments, the actuator 102 is an electrical actuator, such as a moving coil actuator (also known as a voice coil actuator) or a moving magnet actuator. It is understood that although one actuator 102 is illustrated, a system may be configured to include more than one actuator. In the illustrated embodiment, the actuator 102 includes a probe 114 that is moveable in at least one axis. For example, depending on the specific actuator used, the probe 114 may be moved in an x, y and/or z axis relative to the body of the actuator 102. Furthermore, the probe 114 may be rotational (θ) about one or more of the x, y and/or z axes. It is also noted that although the actuator illustrated shows potentially four axes of actuation, an actuator may be provided that has only one axis of actuation. The actuator 102 includes one or more encoders (not shown) that are capable of taking positional measurements about one or more axes. That is, in response to control signals from the controller 104, the actuator 102 sends measurements from its encoders to the controller to indicate the precise positional location of the probe about the relevant axes. In preferred form, the actuator 102 includes one or more pressure or force sensors that are capable of measuring force, e.g., the force exerted by a probe on a contact surface about a given axis. Such positional encoders and force sensors are well known in actuator devices. Additionally, the probe 114 is able to perform a “soft land” operation in which the probe is brought into contact with a surface of the component 110 so as not to damage the surface of the component and also to establish an accurate contact location.

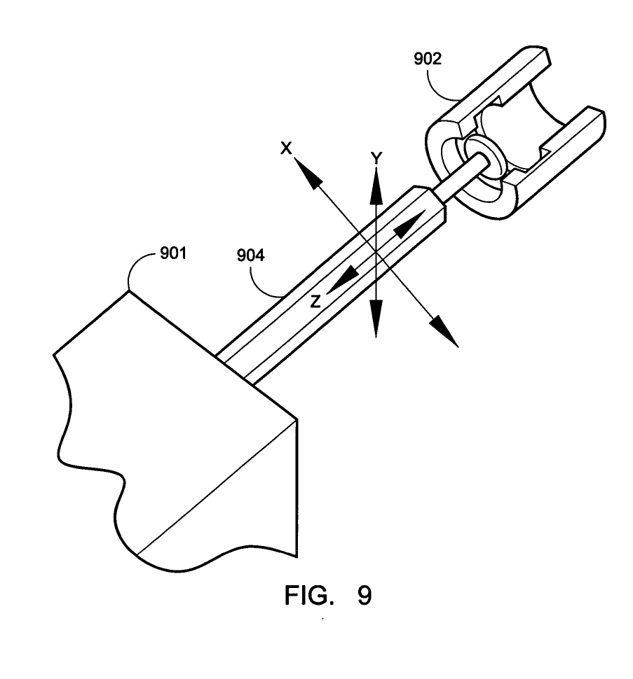

In operation in an inspection system, the probe 114 is moved into position against a surface of the component 110, while positional measurements or locations about one or more axes are recorded. Accordingly, precise dimensions of the component may be measured and compared against stored reference measurements to determine if the actual measurement is within a tolerance value. For example, as illustrated in FIG. 9, a probe 904 is moved to contact different portions of a component 902 in order to verify that critical dimensions (such as inside and outside diameter at various locations, depths, etc.) are within respective input tolerance windows. Typically, the component 110 is moved into or held in an inspection orientation by the handler 112. For example, the handler may be a robotic conveyor or gripper system controlled by the master controller 108 that locates the component at a known reference location relative to the probe 114.

The controller 104 controls the movements of the probe 114. For example, the controller 104 comprises a servo controller that operates a moving coil actuator. The master controller 108, if present, controls the larger assembly and inspection system. For example, the master controller 108 may be a part of an inline assembly system which controls the flow or positioning of the component/s 110 to be inspected by the actuator 102. The master controller sends start/stop signals to the controller 104. In response, the controller 104 controls the inspection process of the actuator 102 and outputs data in the form of measurements or pass/fail results of programmed tolerances. Accordingly, the controller 104 and/or the master controller 108 can determine if the inspected component is acceptable or should be discarded. In another type of inspection, a switch test is performed in which the probe 114 is moved into position to depress a switch while monitoring the force required to depress the switch and/or to hold it in a depressed position. Such forces may be monitored to determine if the switch is within a specified tolerance window.

As is known, the controller 104, such as a servo controller, generates control signals that operate the actuator 102. For example, in accordance with programmed instructions, typically in the form of software, the controller 104 generates controls signals and outputs those signals to the actuator 102 in order to cause movement of the probe 114 about one or more axes.

According to known practices, the controller 104 is programmed to control the actuator 102 depending on the application, i.e., depending on the component to be inspected. For example, the controller 104 includes software that is specifically written to cause the desired actuator movement and measurement for the specific component to be inspected. Typically, a computer is coupled to the controller to generate and transmit software (code representing a set of instructions to be executed) generated in a programming language to the controller for the specific application. Such software, once running on the controller 104, will instruct probe movements and measurements for that specific application or component. In a different application where a different component is to be tested, different programmed instructions or software is needed by the controller to inspect the different component. Accordingly, a software programmer needs to write a separate software program for each application, i.e., a separate software program tailored to the specifics of a particular component. Generally, it is time consuming and expensive to write a specific program for each application.

Therefore, according to several embodiments of the invention, a control system is provided that includes generic programming instructions that are programmable by the user in a non-programming language manner to operate an actuator-based component inspection system in an automated fashion. Thus, the controller 104 is provided with programming instructions (such as software generated by a programmer) stored in memory that allow the user to finalize the programming of inspection controls to the specifics of the given application or component to be inspected, and without requiring that the user have any knowledge of computer code programming. It is noted that these programming instructions are incomplete on their own such that without a motion profile for a specific component, the program instructions are unable to execute an inspection routine or that component. Advantageously, rather than requiring a skilled software programmer to develop a software program to operate the actuator for the given application (including all probe movements, measurements and tolerance determinations), a generic instruction program is developed and provided that includes a non-programming language user interface that allows the user to input and store all probe movements, velocities, time delays, measurements and tolerance measurements that are application specific. Advantageously, the code or instructions comprising the program are the same for different applications, the user inputting parameters defining a motion profile that is used by the programmed instructions to operate the actuator in automated use. It is noted that as used herein, a motion profile may be referred to as stored sequential set of probe movements and actions (such as to cause position measurements) and tolerance values associate with certain measurements that as a whole define the operation of the probe and measurements taken during an inspection routine. Additionally, in several embodiments, the program instructions allowed the user to program separate motion profiles for separate components that may be stored in the input device 106 or the controller 104. Motion profiles stored in the input device 106 can be transferred from the input device 106 to other controllers 104 operating other actuators 102.

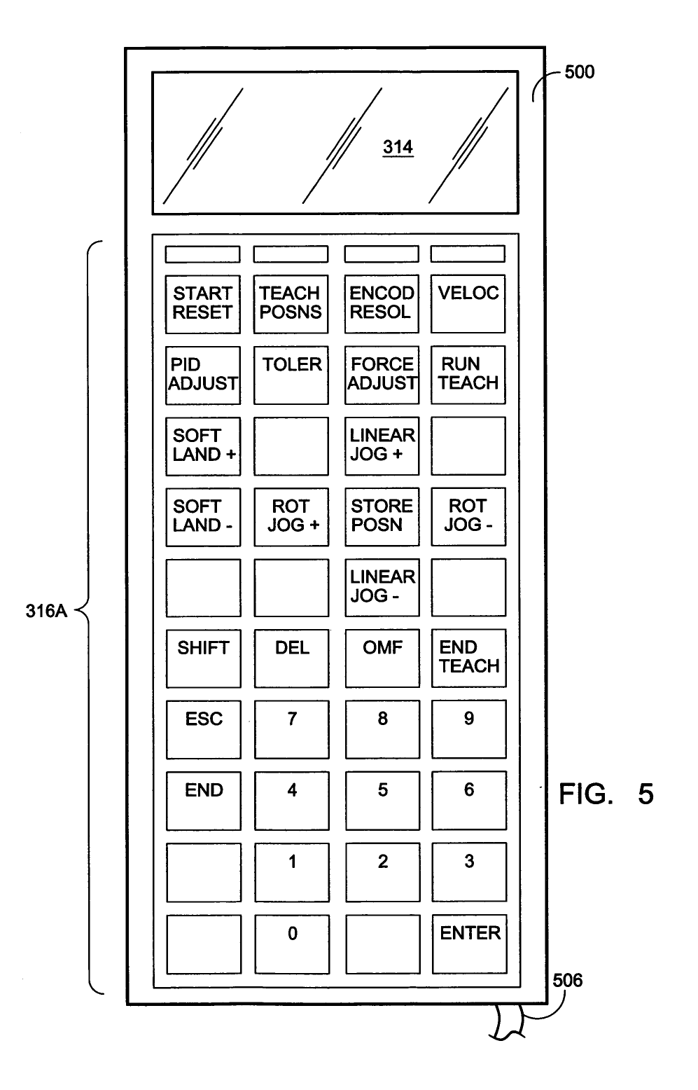

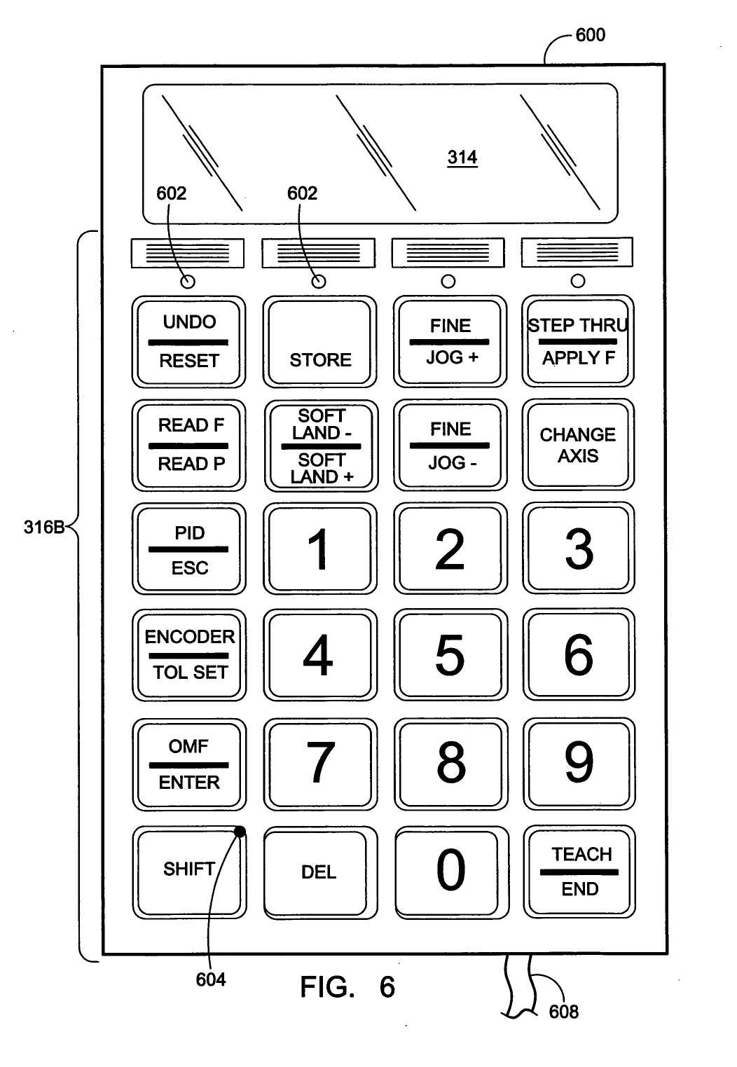

In one embodiment, such a control system including the programming instructions is primarily stored on and executed by the controller 104. In other embodiments, the control system programming instructions are stored on and executed in part by both the input device 106 and the controller 104. In several embodiments, the user interface is embodied in the form of a separate input device 106 that is coupled to the actuator controller 104. The programming instructions or code (implemented as software and/or firmware) of the control system are configured to receive a variety of user input parameters via the input device 106 to establish and store an automated routine or motion profile for automated execution. For example, in one embodiment, the input device 106 is a handheld pendant (such as illustrated in FIGS. 5 and 6). It is understood that the input device 106 may be any device which allows the user to input the desired actuator parameters, e.g., a handheld device, a personal computer, a notebook computer. In preferred form, the input device is coupled to the controller via an RS-232 connection; however, it is understood that such coupling may be of any wireline or wireless means to communicate input data to the controller 104. Additionally, the input device 106 may be a separate device as illustrated or may be physically part of the controller (as indicated by dashed block 116). For example, the controller 104 may include an integrated user key entry means attached to the controller body. It is noted that the programming instructions stored on and executed by the user input device 106 will be different than the programming instructions stored on and executed by the controller 104, but will collectively facilitate the user's ability to store motion profiles.

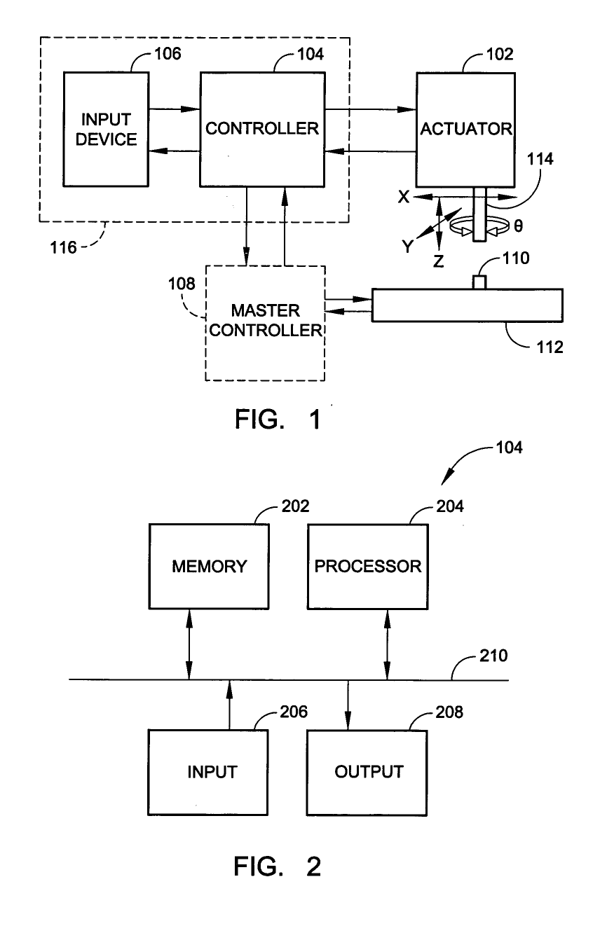

Referring next to FIG. 2, a hardware block diagram is shown of portions of a control system implemented for example in the controller 104 of FIG. 1. The controller 104 includes a memory 202, a processor 204, an input 206, an output 208 and a bus 210. Generically, the control system programming instructions are stored as code or a set of instructions in the memory 202. This code is executed or run by the processor 204 in order to implement the functionality of the code. For example, portions of the programmed instructions are retrieved from memory 202 by the processor 204 and executed using other information stored in memory 202 (e.g., as input by the user) and/or input information received from the input device 206. In use, one or more generated outputs (such as actuator control signals, pass/fail signals, etc.) are output via the output 208. The input 206 may receive inputs from the input device 106, inputs from the master controller 108 or inputs in the form of measurements (such as encoder readings) or other feedback from the actuator 102. The output 208 may send outputs to the actuator 102, to the master controller 108 and/or to the input device 106.

It is understood that although a single memory 202 is illustrated, the memory 202 may comprise one or more separate memory devices. It is noted that the memory 202 may be any type of non-volatile memory device, random access memory (RAM), or read only memory (ROM). Generically, the memory 202 may also be referred to as a computer readable medium. In a broad sense, the memory or computer readable medium refers to any type of medium that stores instructions executable by a processor, machine or computer. For example, the memory or computer readable medium may be any type of memory device. In several embodiments, the computer readable medium is a removable medium, such as a flash drive, floppy, hard, compact disc (CD), digital versatile disc (DVD), etc. Furthermore, the programming instructions stored on the memory 202 may be software and/or firmware. It is further understood that the processor 204 may comprise any type of microprocessor, digital signal processing unit, logic array, field programmable gate array (FPGA). According to several embodiments, programming instructions are provided that are stored on a memory or a computer readable medium as a set of instructions to be executed on a processor or other machine. Such instructions allow a user to program or teach an automated actuator control system a motion profile for a specific application. In several embodiments, a motion profile is a set of register values stored in memory. Once the system is taught a motion profile, the programmed instructions use the stored motion profile to operate the actuator-based automated inspection process. Thus, without the motion profile, the programmed instructions are not able to execute an inspection routine of a given component.

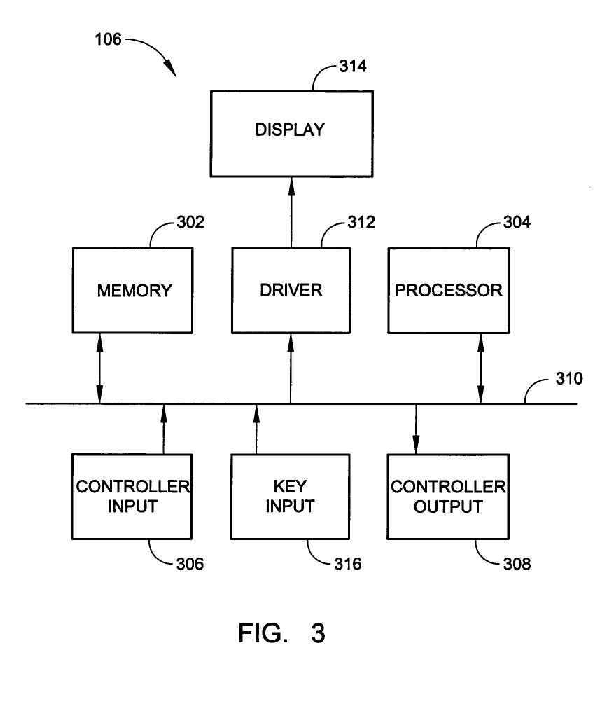

Referring next to FIG. 3, a hardware block diagram is shown of several components of a user input device for use in combination with the controller of FIGS. 1-2 in accordance with one embodiment of the invention. The input device 106 includes a memory 302, a processor 304, a controller input 306, a controller output 308, a bus 310, a display driver 312, a display 314, and a key input 316 (including keys, buttons, etc.).

The controller output 308 allows data and instructions from the input device 106 to pass to the controller 104, while the controller input 306 receives data and instructions from the controller 104. The key input 316 allows direct user interaction with the input device 106 to be received as control signals to be processed by the processor 304. The programming instructions for the input device 106 are stored as code or a set of instructions in the memory 302. This code is executed or run by the processor 304 in order to implement the functionality of the code similar to described with reference to FIG. 2. For example, portions of the programmed instructions are retrieved from memory 302 by the processor 304 and executed using other information stored in memory 302 and/or input information received from the controller input 306 and/or the key input 316.

Similar to that described in FIG. 2, it is understood that the memory 302 may comprise one or more separate memory devices and that the memory 302 may be any type of non-volatile memory device, random access memory (RAM), or read only memory (ROM). Generically, the memory 302 is also referred to as a computer readable medium. Furthermore, the programming instructions stored on the memory 302 may be software and/or firmware. It is further understood that the processor 304 may comprise any type of microprocessor, digital signal processing unit, logic array, field programmable gate array (FPGA).

The programmed instructions stored in the memory 302 allow the input device 106 to process the various inputs and outputs to and from the controller 104, and provide a user interface to the user through the display 314 and the user key inputs 316. In order to implement the display 314, processor 304 sends the appropriate instructions to the display driver 312, which in turn, causes the display to display the desired information to the user (e.g., to prompt the user to perform a task). In preferred form, the display 314 may include one or more different display devices, such as a liquid crystal display (LCD) and light emitting diodes (LEDs).

In many embodiments, the programmed instructions in the memory 302 allow the user to enter and store one or more motion profiles corresponding to different components to be inspected by the actuator in cooperation with the programmed instructions stored in the memory 202 of the controller 104 that control the actuator 102 based on user entered parameters at the input device 106 that are forwarded to the controller 104. In some embodiments, the memory 302 is used to store multiple motion profiles. In other embodiments, the programmed instructions allow the stored motion profiles to be transferred from the input device 106 to additional controllers 104. Furthermore, in some embodiments, the programmed instructions stored in the memory 302 allow for motion profiles that are generated elsewhere to be transferred into the input device 106.

In even further embodiments, the memory 302 is used to store the “core” programming instructions that are to be used by a controller 104. One or more of these “core” programming instruction sets can then be transferred from the input device 106 to the controller 104. In one embodiment, a “core” programming instruction set (e.g., implemented as software and/or firmware) refers to the programming instructions that would be required by a controller 104 in order to allow a user to program a motion profile as well as to operate the actuator, except that the core programming instruction set is specific to the type of actuator 102 that is being controlled by the controller 104. For example, a first core programming instruction set is developed that is specific to a controller that controls an x-y actuator, a second core programming instruction set is developed that is specific to a controller that controls a linear and rotary (x and θ) actuator, and a third core programming instruction set is developed that is specific to a controller that controls an x, y, z and rotary actuator. The input device 106 stores multiple core programming instruction sets that may be selectively transferred into a given controller 104, from a computer, for example.

In preferred form, the stored motion profile/s in the memory 302 and/or 202 as programmed by the user comprises a set of registers in memory that each stores the commands and parameters needed for the particular inspection routine and component. Once the system is taught a motion profile, the programmed instructions can use the stored motion profile to operate the actuator-based automated inspection process.

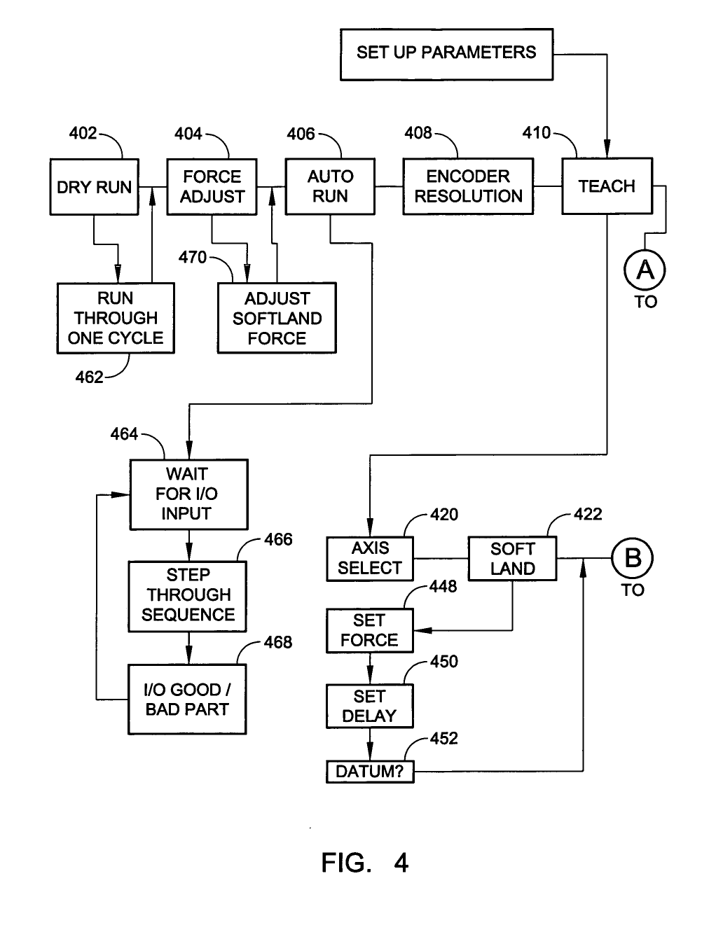

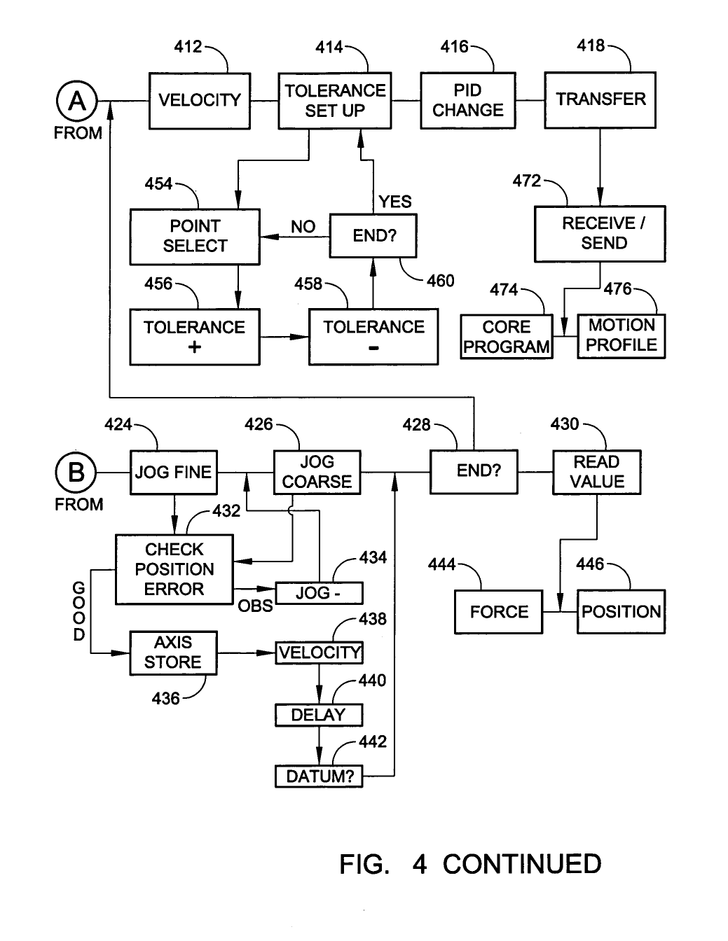

Referring next to FIG. 4, a flowchart is shown of the functionality of the programming instructions for the programmable and automated control system of the actuator-based inspection system of FIG. 1 according to one embodiment of the invention. Concurrent reference will also be made to FIGS. 5 and 6, which show different embodiments of an input device 106 that allows a user to program an automated inspection and measurement routine and input tolerances. Input devices 500 and 600 each have separate user key inputs 316A and 316B, respectively.

According to several embodiments, the actuator controller 104 and the input device 106 collectively store the programming instructions (e.g., as software and/or firmware) to allow the user to teach or input the specific parameters required to inspect a desired component in an automated inspection process. In preferred form, an input device 106 (such as the input devices 500 or 600 of FIGS. 5 and 6) is provided to allow the user to input parameters for the application. The programming instructions of the controller 104 include (1) a user interface configured to receive the input parameters from and control signals to and from the input device 106, (2) an actuator interface to send and receive instructions and data to and from the actuator 102, and (3) a master controller interface to send and receive instructions and data to and from the master controller 108. The user input device 106 includes the programming instructions to implement (1) a user interface (e.g., via the key input 316 and the display 314) to allow the user to input a motion profile and (2) a controller interface to send and receive instructions and data to and from the controller 104. Thus, the programming instructions of the input device 106 and the controller 104 are intended to cooperate to provide the user the programming abilities as described herein. In one embodiment, the pendant or user input devices 500 and 600 and the corresponding user interface are simple to use and do not require programming expertise, and the input device 500 is coupled to the controller 104 via an RS-232, EIA-232, EIA-422 or EIA-485 connection, for example.

The functional flow diagram of FIG. 4 illustrates many of the functions provided by the programming instructions in the controller 104 and the input device 106. Top level functions of the programming instructions include: teach 410; encoder resolution 408; tolerance set up 414; dry run 402 (also referred to as “step through”); auto run 406; PID change 416; force adjust 404; velocity 412, and transfer 418. It is understood that such functionality is provided by way of example, and is not meant to be limiting to only that functionality listed. One of ordinary skill in the art can add other functionality. The following describes many of the top level functions of the program flowchart of FIG. 4, not necessarily in any particular order.

### Teach

The Teach function 410 allows the user to input all positional changes of the probe 114 in order to define a motion profile or inspection routine for the specific application. The user essentially teaches the steps or motions and timing of the actuator probe and any corresponding positions where measurements are to be taken in going through the inspection process for a given known part or component and stores these steps and actions as a motion profile. For example, the user presses the TEACH POSNS button on the pendant 500 (or the TEACH button of the input device 500) to activate this functionality.

According to several embodiments, the control programming instructions allow the user to positionally adjust the actuator probe 114 in one or more available axes (e.g., x, y, z and/or rotation) as well as instruct that measurements be recorded at certain positions. The user starts with a known reference component in a known position relative to the probe. Following FIG. 4, once the “teach 410” functionality is activated, the user can: select axis 420, soft land 422, jog fine 424, jog coarse 426, read value 430, and end 428. “Select axis 420” allows the user to specify an axis of actuation that the user wishes to cause a location change. For example, on a linear rotational actuator, the user selects either the position (z) axis or the rotation axis (rotation θ about the z axis). In one example, the user presses an axis select button, such as the CHANGE AXIS button of the input device 600 repeatedly until the desired axis is selected and displayed (on display 314), then the user presses ENTER.

Once the axis is selected, the user uses the “jog” function to move the probe about the selected axis. Jog Coarse 426 moves the probe 114 a large distance per step while Jog Fine 424 moves the probe 114 in smaller or finer increments to closely position the probe at the desired location. For example, the user presses the LINEAR JOG+ button or the LINEAR JOG− button of input device 500 to cause the appropriate probe movement along a selected linear axis. The SHIFT button may be used to distinguish coarse and fine jog commands. It is important to note that when the user inputs the jog commands to the control system, the control system receives these parameters, translates them into control signals usable by the actuator and sends the appropriate signaling to the actuator to cause the selected motion to occur. Thus, the probe is caused to move based upon the input parameters and the user can visually verify that the probe is moving as desired relative to the component. It is noted that the input device 500 also includes a ROT JOG+ button and a ROT JOG− button to provide a rotational jog about an axis. Again, the SHIFT button may distinguish coarse and fine jogs. It is further noted that the input device 500 is generally configured for a two axis actuator (such as a z and rotation actuator, e.g., described in U.S. Pat. No. 5,518,682, which is incorporated herein by reference) and thus, does not require a separate AXIS SELECT button like the input device 600. This is because depending on which button is pressed (ROT JOG or LINEAR JOG), the axis is necessarily selected. However, one could easily design an input device that would have more than 2 axes of actuation, e.g., a 4 axis actuator. In one example, the input device 600 includes an axis select (CHANGE AXIS) button and a JOG+ and JOG− buttons, as well as a SHIFT key to switch between coarse/fine jogs.

Additionally, the control system and control program are configured to receive an indication from the actuator 102 whether the position change the user has directed is in error. For example, if the instructed position change on a given axis results in the probe hitting an obstruction (e.g., an obstruction is encountered when more than a threshold amount of force to continue movement of the probe 114 in the desired direction is needed), an error signal is sent back to the controller 104 and forwarded to the input device 106, which displays an indication to the user (alternatively, the controller 104 receives and processes the error signal and then sends a signal to the input device 106 to cause it to display the indication). Thus, the programmed instructions of the input device 106 (or the controller 104 depending on the embodiment) check for position errors 432. If the error is detected (an error feedback signal is received from the actuator 102), the program instructions (typically of the controller 104) automatically run a jog minus (“jog−” 434) step back to the previous location. If there are no obstructions, the program prompts the user to store the axis location (axis store 436) via the display 314. The user may store the location (at 436) or may further jog the probe to another position about the selected axis. Once the user is satisfied with the location of the probe and there are no obstructions (432), the user saves the new position (436). For example, the user presses the STORE POSN button on the input device 500 or STORE on the input device 600.

In some embodiments, an obstruction is defined when the probe encounters an obstruction that requires more than a threshold amount of force (also referred to as a force error) to continue movement of the probe 114 in the desired direction. For example, it may be desired that the probe contact and depress a button or switch, and thus, an error should not occur on initial contact. In use, the probe will contact the button and continue to move as directed by the user to depress the button until the button can not be pressed further. At that point, the force required to continue movement of the probe would exceed a defined threshold value in order to prevent damage to the button or component being inspected.

Next, the programmed instructions of the controller and/or the input device provide the user the opportunity to define the transit time from the previous stored location to the currently stored location. In other words, the user can program the velocity (438) from the previous location to the current location. Next, the programmed instructions of the controller and/or the input device provide the user the opportunity to define the delay time for the probe to remain at the currently stored position (440). In other words, the user can program how long the probe 114 stays at the currently programmed location before beginning to proceed to a subsequent positional location. For example, once the location is stored (436), the input device 106 prompts the user (via display screen text) to enter numerical values for the velocity and delay time. In one embodiment, the user interface display 314 prompts the user to enter a number (e.g., using the number keys and pressing ENTER); however, it is understood that there may be dedicated buttons (e.g., the VELOC button on input device 500) to enter these values. In one implementation, the numerical value entered for the velocity corresponds to the number of encoder counts/time period (such as encoder counts/second). Alternatively, the numerical value entered for the velocity corresponds to the distance/time period (such as millimeters/second). Also, in one implementation, the numerical values entered for the delay time is in time units, such as a number of milliseconds to remain at the currently stored position.

In one embodiment, after storing the position (436) and the optional steps of setting the velocity (438) and delay (440), the user is prompted (via the display screen) to indicate whether the stored location should be a datum point (442). A datum point is typically a reference probe location that subsequent probe movements are referenced to or moved from. In some embodiments, it is similar to the actuator home index point, but is more specific to the component being inspected. In one embodiment, the user is prompted by the display screen text (generated by the input device 106) to enter whether the stored location should be a datum point. In one example, the user presses “1” and ENTER to mark the location as a datum point and “2” and ENTER otherwise.

Another user selectable function within the TEACH 410 functionality is the read value 430 function. This function allows the user to indicate that a reading or measurement should be taken at the currently stored location and axis. For example, the user will be prompted to input whether a force (444) or position (446) reading is desired at a given probe position. In one implementation, the user is prompted via the display 314 whether or not a reading should be taken. In another form, a dedicated button or key is provided, such as the READ F (force)/READ P (position) button of the input device 600, which is toggled using the SHIFT button. It is noted that the program instructions generally cause the display 314 to display a user selection so that the user can easily verify that the intended selection is the selection that was entered. The read function 430 causes controller 104 to send controls signals to the actuator 102, which sends back its readings from the appropriate encoder back to the controller 104 and/or input device 106 to be stored as a reference measurement that is part of the motion profile. In use, these reference measurements are compared to actual measurements for a component being inspected to see if a given dimension is within tolerance for quality control purposes. In some embodiments, the user enters a numerical code that indicates what the specific reading and axis should be should be obtained from the actuator 102. For example, if the change in position from one location to the stored location is to be measured, the code will indicate so and the actuator will send measurement data from an appropriate encoder back to the controller 104.

Then, the user then selects the next position to store. In the process, the user stores sequential positions of the probe 114 about one or more axes, resulting in a stored probe motion profile or inspection routine. Advantageously, the user is able to see the probe movements as they are being programmed or taught in order to visually verify that the programmed motion profile is what the user intends.

It is noted that once the position is stored, the user may go directly to another function within the teach functionality without selecting axis select, if the same axis is to be modified.

If the user wishes to perform a soft land about a given axis, the user enters the “soft land” 422 functionality of the software. The ability to soft land against a surface is known in the art and described for example, in U.S. Pat. No. 5,952,589 (which is incorporated herein by reference). To perform a soft land, the probe 114 is caused to move in a direction of choice (about a selected axis, by performing the axis select 420 function) and make a soft landing on a contact surface in order make a determination of the point of contact with the surface. For example, the user may jog the probe to a known position proximate to a surface of the component (store that position and a corresponding measurement), then program the probe to move about the selected axis until a soft land occurs. At this point, the positional location of the probe at contact is recorded into order to determine a dimension of the component 110. This dimension is used as a reference value which will be compared to the same dimension measured on a subsequent component being inspected. By comparing the difference between an actual and reference measurement or reading to a tolerance window, the dimension is determined to pass or fail the inspection. For example, the user presses the SOFT LAND+ button or the SOFT LAND− button (or combined button of the input device 500, which is toggled using the SHIFT button) to cause the soft land in the specified direction on the selected axis. It is noted that any time the user teaches or programs a soft land along a given axis, the programmed instructions are automatically configured to take a position reading at the point of contact, and the user will be later prompted to enter a tolerance value corresponding to the reading. In the embodiment of FIG. 4, the user is provided an option to set the force (448) of the soft land, that is, define how forceful the soft land should be. In one form, the user enters a numerical value corresponding to the force and selects ENTER. Then, the user is prompted to enter the delay time (450) that the probe will remain at the soft land position, e.g., by entering a numerical value corresponding to time units, such as milliseconds. Next, the user is provided the option to mark the soft land location as a datum point (452) similar to the datum point step 442 under the Jog menu.

The user can variously program probe movements to achieve a variety of results. For example, in one embodiment, the user can use jog and soft land controls together to implement a “switch test”. For example, the user can program the probe to soft land against a contact surface of the switch or button being tested or inspected in order to find the button surface, then program the probe to jog to a position sufficient to depress the button or move the switch, and then read a force to hold the switch in position. Accordingly, the user may specify how long the switch is depressed, or more generally, how long the probe remains at a given location or specify a length of time to transition from one location to another.

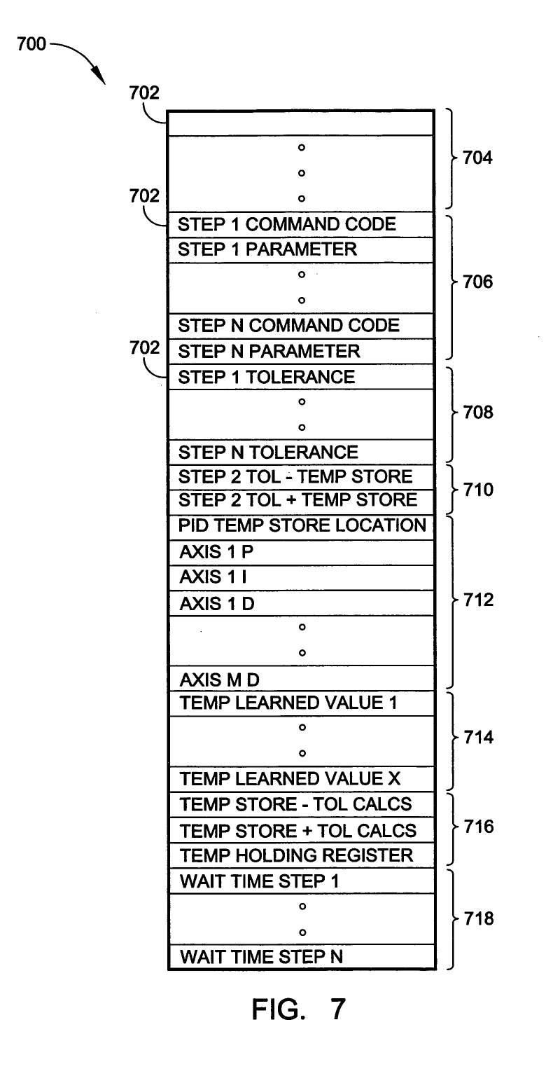

Advantageously, according to several embodiments, programming instructions (in the form of software and/or firmware) are provided between the controller 104 and the input device 106 to allow the user to teach a motion profile or inspection routine to the actuator controller that is specific to the application or component to be inspected. For example, a motion profile may include the steps of: (1) move to a first position; (2) soft land along a given axis to a second position and measure (or read) the probe position; (3) retract to third position; (4) move to a fourth position; (5) soft land along a given axis to a fifth position and measure probe position; and so. Each move to position may involve position changes of one or more axes. Additionally, the user may set other parameters, such as velocity, delay time, define datum points, etc. as well as encoder reading points that become part of the stored motion profile. In one embodiment, the stored motion profile is a series of registers in an array of memory, the registers storing values that define all of the parameters specific to the particular component (as further described with reference to FIG. 7). Furthermore, since the controller 104 is configured to cause all probe movements to be executed as the motion profile is being generated, the user can visually verify that the motion profile is inspecting as it is intended to do. By providing the generic programming instructions for the controller 104 and the input device 106 that allow the user to “program” the control system with a motion profile to fit the application, the software programmer does not have to write a specific set of code for the specific application and the user can effectively finalize the control system using a simple user interface and without requiring programming language skills.

### Tolerance Set Up

The Tolerance Set Up function 414 allows a user to define tolerance windows for various measurements taken during the inspection process relative to reference measurements. In one embodiment, when the user stores a specific action as part of the inspection routine being taught (e.g., under the TEACH function 410), the user can specify that a given measurement be taken. For example, the user can program a soft land 422, or a read value 430 (as either a read force 444 or a read position 446, or by a code that is assigned to a stored position or action, the code indicating what type of measurement is to be recorded). In Tolerance Set Up 414, the user can specify a window of acceptable variance about a stored reference measurement taken during teaching. In one embodiment, the control system program instructions are configured to go through each stored position/action that requires a measurement (or has a stored reference value) and prompt the user to enter a tolerance value. For example, the user is prompted to select a store point (“point select 454”). If the user wishes to add a tolerance window to that measurement, the user can enter a tolerance “+” value 456, then a tolerance “−” value 458, which represents the encoder count above and below the measured or read value to set the tolerance window. In one embodiment, at the tolerance “+” and “−” prompts, the user enters the number of encoder counts (as either position or force) either above or below the measured reading or value. These tolerance values are stored as part of the motion profile being taught. For example, once the inspection routine is running if the measurement of the inspected part is within 5 encoder counts of the target measurement (at the stored location), then the dimension is within the tolerance window (of ten encoder counts). After a tolerance window is entered (456, 458) for a given point, the user is prompted to enter a tolerance window for the next point which needs a tolerance (454), until all points have tolerance windows assigned thereto (at end 460). It is noted that a tolerance may be specified in terms of encoder counts, measurements, numerical inputs, etc. For example, to enter tolerance set up, the user presses the TOLER button on the input device 500 (or TOL SET on the input device 600). The number buttons (1, 2, 3, etc.) of the input devices 500 and 600 may be used to input tolerance values, or plus and minus tolerance count buttons may be provided.

In preferred form, tolerance values are entered by the user after probe motions have been taught and stored in the motion profile. However, in other embodiments, the tolerance values may be prompted to be entered by the user during the Teach function 410.

### Encoder Resolution

The Encoder Resolution function 408 allows the user to input a resolution of an encoder of the actuator 102. For example, a given encoder may have a resolution of 1 micron, while another has a resolution of 5 microns. Depending on the embodiment, encoder resolutions may be different for different axes. For example, to enter an encoder resolution, the user presses the ENCOD RESOL button on input device 500 and ENCODER on input device 600. The user may then select an encoder to enter the appropriate resolution.

### Dry Run (Step Through)

The Dry Run function 402 (also referred to as the Step Through function) allows the user to step through a routine that the user has taught the controller (using the TEACH function). Function 462 allows the user to step through the motion profile one cycle. For example, once the user has programmed a motion profile or routine of actuator probe location/position changes, timing and measurements, the user can trigger the controller 104 to walk through the automated routine. Advantageously, the user may make adjustments to the routine before finalizing. For example, to enter a dry run, the user presses the RUN TEACH button on the input device 500 or the STEP THRU button of input device 600. In some embodiments, the user is prompted to adjust the velocity of the dry run, for example, to make it easier for the user to visually verify the inspection routine.

### Auto Run

The Auto Run function 406 allows the user to begin operation of the programmed or taught motion profile or routine in a fully automated manner with components to be inspected and which, in many embodiments, results in outputs signals indicating whether the component has passed all tolerance windows. It is noted that although this function may be initiated by the input device 106, the input device 106 is not required for the execution of the automated inspection routine (assuming that the motion profile has been stored in the controller 104 or otherwise transferred from the input device 106 to the controller 104). In auto run 406, the program instructions of the control system wait for a start/reset signal 464 from a master controller or other start signal (such as from the input device 106). Then, the control system steps through the motion profile in sequence (466) moving the probe as programmed and taking readings or measurements. These readings are compared to reference tolerance values stored in the motion profile in order to cause a good/bad part signal to be output (468). If the actual measurement on an inspected component is outside of a tolerance window of the variance about the reference measurement, then the programmed instructions implementing the control system cause a fail signal to be output, e.g., to the master controller 108. If the tolerance is met, then a pass signal is caused to be output. Once a complete cycle of the motion profile or routine is complete, the system waits for subsequent commands from the master controller 108 or the input device 106, such as to start over once the next component to be inspected is positioned for inspection. In one example, to enter the auto run, the user presses the RUN TEACH button on the input device 500. Use of the SHIFT key may distinguish between a Dry Run and an Auto Run.

### PID Change

The PID Change function 416 allows for changes or adjustments in the various parameters of the system due to measured conditions in use. This includes proportional, integral and derivative (PID) changes in values. For example, global changes may be needed once a routine has been taught to compensate for other variances in the manufacturing or actuating process. For example, to enter the PID Change function, the user presses the PID ADJUST button on input device 500 and the PID button on input device 600.

### Force Adjust

The Force Adjust function 404 allows a user to make changes in the force, e.g., adjust soft land force (470). This may account for changes in the actuator over time. For example, the user enters this function by pressing the FORCE ADJUST button.

### Velocity

The Velocity function 412 allows a user to control or alter the overall velocity of the programmed inspection routine or motion profile. For example, during initial testing runs of the routine, the routine is run slowly to verify the accuracy and completeness of the routine. However, once the inspection process is used in conjunction with an inline assembly and inspection process, the inspection process is sped up to run at production velocities. For example, to enter the velocity adjust function, the user presses the VELOC button on the pendant.

### Transfer

The transfer function 418 allows the user to transfer stored motion profiles and/or “core” programming instruction sets between the input device 106 and the controller 104. In one embodiment, the motion profile as taught by a user described above, for example using the teach function 410 and the tolerance set up function 414, is to be transferred or downloaded to the memory space of the controller 104.

In some embodiments, the programmed instructions allow the stored motion profiles to be transferred from the input device 106 to the controller 104, or to additional controllers 104. For example, the input device 106 may be programmed with one or more motion profiles using a given controller 104, then disconnected from the controller and then connected to each of several other controllers that are also to inspect the same component. By allowing the input device to be able to transfer a stored motion profile to another controller, the user does not have to re-program or re-teach another controller 104 the same motion profile—it is simply downloaded into the new controller. Likewise, a motion profile stored in a controller 104 can be transferred or uploaded to another input device 106. Thus, the programmed instructions stored in the memories of the controller 104 and the input device 106 allow for motion profiles to be transferred in or out. Additionally, as described herein, an input device 106 can be configured to store multiple motion profiles, each motion profile corresponding to an inspection routine for a given component. Thus, the user can select which stored motion profile to transfer out or in.

In preferred embodiments, the transfer function 418 allows “core” programming instructions (core programs) that are stored to be transferred in or out of the particular device. For example, a core programming instruction set stored in the controller 104 can be transferred to the input device 106. Additionally, a core programming set stored in the input device 106 can be transferred to the controller 104. In preferred form, the memory 302 of the input device is sufficient to store multiple core programming instruction sets, and a specific core program is then transferred to the controller 104 depending on the type of controller. In one embodiment, a “core” programming instruction set (e.g., implemented as software and/or firmware) refers to the programming instructions developed by a programmer that would be required by a controller 104 to operate an actuator and in order to allow a user to program a motion profile, except that the core programming instruction set is specific to the type of actuator 102 that is being controller by the controller 104. For example, a first core programming instruction set is developed that is specific to a controller that controls an x-y actuator, a second core programming instruction set is developed that is specific to a controller that controls a linear and rotary (x and θ) actuator, and so on. The input device 106 stores multiple core programming instruction sets that may be selectively transferred into a given controller 104.

Under the transfer functionality 418, the user selects whether the action will be a send or receive (472), then the user selects whether to send or receive a core programming instruction set (474) or a motion profile (476). If there are multiple available core programs or motion profiles, the user then selects which core program or which motion profile the user will send or receive. In many embodiments, the user enters the information via the user interface (display 314 and key input 316) at the input device 106. In order to send the selected item from the input device 106 to the controller 104, the input device includes instructions to cause the contents of the memory storing the selected item to be copied to the memory space of the controller, which also includes programming instructions to receive the copied profile or program and store it into its own memory space. Similarly, in order to send a selected item from the controller 104 to the input device 106, the input device includes instructions to send signaling to the controller to cause the selected contents of the memory of the controller to be transferred and stored in the memory of the input device 106 (which can be referred to as “scooping” data from the controller memory 202).

It is noted that the input devices 500 and 600 provide a few examples of a user input device that provide parameter inputs via a user interface of the control system programming instructions. One of ordinary skill in the art will appreciate that other variations are possible.

Other buttons not mentioned above include START/RESET to start or reset user input function; ENTER to enter or affirm a choice; ESC to break out of the main routine running the controller 104; END TEACH to end the user teaching function; DEL to delete an entry; UNDO to undo an action; OMF to stop all functions or turn off all actuator motors; STORE to store a parameter; APPLY FORCE to cause the probe to apply a force to a surface of the component for a specified period of time (e.g., to assemble two components, after which the user could check the positions to verify that the two parts have been correctly assembled); and END to end the user input function or disconnect the pendant. It is understood that depending on the functionality, the pendant may have more or less input keys. Additionally, the input device 600 includes light emitting diodes (LEDs) 602 as a part of the overall user interface to indicate power and other functions. LED 604 is lit when the SHIFT button has been pressed. Such LEDs may be driver by the display driver 312. Additionally, the input devices 500 and 600 include a communication line 506 and 606 to allow data and control signaling to pass between the input device and the controller 104. In one embodiment, the user input 106 is operated using DC power (such as a battery) or can be configured to receive external power.

According to some embodiments, the input device 106 includes memory to store the programmed motion profile. Thus, such a profile may be downloaded to other controllers inspecting the same component, e.g., in a redundant assembly/inspection lines of the same component. Additionally, such memory may be used to store different core programs that are specific to different actuator devices. For example, core programs or programming instruction sets may be stored that relate to x/y actuators, x/y/z actuators, z/rotation actuators, etc. Core programs may also be stored for different types of actuators, e.g., pneumatic, hydraulic, electrical actuators.

The programming instructions (stored as software and/or firmware) running in the controller 104 and the input device 106 allow the user to program the actuator control system for the specific application and provides a mechanism to control the actuator according to the profile and compare actuator measurements with reference measurements and tolerances input by the user to output pass/fail indications for specific component parameters. In one embodiment, the functionality of the programming instructions of the control system can be thought of as providing a user interface so that the user can teach an application specific profile and controller functionality to execute the inspection process.

### Example—Control System Program Features

In one embodiment, the controller 104 includes the core source code or programming instructions that enables it to interact with the actuator 102, the master controller 108 and the input device 106. These instructions cooperate together with the programming instructions in the input device 106. These instructions enable the input device to send variables to the controller, these being entered by the user setting up the program. Once the motion profile is taught and loaded into the controller 104, the generic programming instructions in the controller use the stored motion profile to run the automated actuator-based inspection process and determines tolerance pass/fail conditions without further need for the input device 106.

In one embodiment, the control system programming instructions have the following capabilities; however, it is understood that in many embodiments, more or less features will be provided in the controller program instructions. These instructions (together with the instructions of the input device) provide a non-programming language based interface for the user to input variables to program or teach a motion profile to be automated (e.g., provides an interface to a user input device such as a pendant). Various program functions to store or generate the motion profile include, but are not limited to: teach, axis select, coarse/fine jog, soft land, switch test, step back, set tolerance, dry run, auto run, velocity, store, delete, force adjust, time set, master shut off. The programming instructions (or core program) allows the input device-taught values/positions to be stored in non volatile memory. The program instructions are flexible and generic so that the execution of the inspection process will be sequenced depending on the commands from the input device 106 during teaching.

Other features of the program instructions of the controller in this example include that they can drive a device such as an actuator. The program provides configurable input and output channels that can output data to a master controller 108, the input device 106 or other remote device (even include the input device 106) to data log measurements. The program instructions also provide for single or multi-axis function capability. Additionally, the program provides for error check functions to check for obstructions in motion path. Additionally, the program provides arithmetic comparison for values (including force and position) for pass/fail analysis. Inputs and outputs are settable for use with external controlling systems (such as the master controller 108). Additionally, in preferred form, the program instructions of the controller 104 are configured such that the controller 104 can be integrated into an existing automated system (e.g., having master controller 108), or can be stand alone (e.g., no master controller is present). Furthermore, the controller program allows it to run continually with or without the use of the input device 106 after the teach routine (motion profile) is completed and stored in the memory of the controller.

### Example—Input Device Features

In one embodiment, the programming instructions of the input device have the following capabilities; however, it is understood that in many embodiments, more or less features will be provided in these program instructions. The instructions allow the user to input variables for use with the controller programming instructions (e.g., the controller software) to program a motion profile. In one embodiment, the user can use the input device to set parameters for functions such as: Teach Function (used by user to setup parameters and moves); Select which axis to operate the desired moves; Jog to positions (Course and fine, Positive or Neg. directions); Soft Land (Control force, both in pos. and neg. directions); Store Positions (Multiple positions of multiple axes); Step back to desired position; Set Tolerances (For the different parameters being checked); Run, Auto Run, Auto Jog; Variable Velocity (change velocity of motion profile); Time set (set time at a position or to change positions); Obstruction interrupt (Safety check); Master shut off (all axis motor off, e.g., 0MF button); Backspace/delete functions; optional memory storage for storing core programs and additional motion profiles; Transfer functions to allow the transferring in and out of core programs and motion profiles.

Referring next to FIG. 7, a diagram illustrating a portion of memory is configured to store a motion profile in accordance with one embodiment of the invention.

In several embodiments, the motion profile is stored as a series of registers 702 in a memory array 700. Each register has a number stored therein that corresponds to data or a code. In one form, each register is 32 bits in length, but such length will vary depending on the implementation. For example, a first grouping 704 of registers includes several different types of registers. For example, the types of registers in this grouping include, but are not limited to: an accumulator register used for processing; unused registers (e.g., for overflow from the accumulator register); encoder resolution register/s to store encoder resolution values; an autorun counter register; a measured value at auto soft land register; a temporary store start position for soft land register; a default tolerance register; a command code location register; a command parameter register; a minimum tolerance value location register; a maximum tolerance value location register; and a counter for base tolerance register.

A second grouping 706 of registers alternatingly store a command code and a parameter for each action that is part of the motion profile. For example, if the user intends to jog the probe along axis 1 in step 1, a code corresponding to the action of jogging along axis 1 is stored in the Step 1 command code register. Also, a parameter is stored for each step. For example, the Step 1 parameter register stores how far to jog along axis 1. Other parameters could include force and velocity, for example. Accordingly, in the teaching of the motion profile, a command code and a corresponding parameter are stored in consecutive registers for each step in the motion profile. Command codes can represent many types of available commands, including but not limited to: axis move, axis read position, axis read force, jog+, jog−, fine jog+, fine jog−, soft land+, soft land−, store position, step back, change axis, set tolerance.

A third grouping 708 of registers stores tolerance levels input by the user for each step. A fourth grouping 710 of registers stores temporary values for tolerance during the teach routine. A fifth grouping 712 of registers stores PID change parameters for each available axis. A sixth grouping 714 of registers stores temporary values for learned positions during the teach routine. A seventh grouping 716 of registers stores temporary values for tolerance calculations during the teach routine. A eighth grouping 718 of registers stores the wait time or delay spent at each position for each Step.

In preferred form, the core programming instructions are configured to be able to read the register values of the motion profile and is configured to know the precise order of the registers (just not the content) at the time of the development in order to run the control and inspection system processes tailored to the specific component to be inspected. In preferred embodiments, the motion profile is stored as a .txt file in the memory array. Additionally, in preferred form, multiple motion profiles are stored in the memory of the input device 106, such that multiple memory arrays having the same structure as memory array 700 are repeated with each having different values in each register. It is understood that there could be any number of additional registers depending on the implementation. For example, there may be separate force registers and separate velocity registers.

Referring briefly to FIG. 12, a sample motion profile is illustrated according to one embodiment. For each program step 1202, horizontally illustrated are: the command register number 1204; the command register value 1206 (a code that corresponds to an action); the action 1208 corresponding to the command register value or code; the velocity register number 1210; the velocity register value 1212 (a number representing the velocity); the force register number 1214, the force register value 1216 (a number representing the force); the wait time register number 1218; and the wait time register value 1220 (a number representing the number of milliseconds). As can be seen, for each step, the values of the registers define the motion profile as taught by the user. It is noted that in this embodiment, there are separate force and velocity registers in the registers comprising the memory array, although in other embodiments, these values could be stored in step parameter registers.

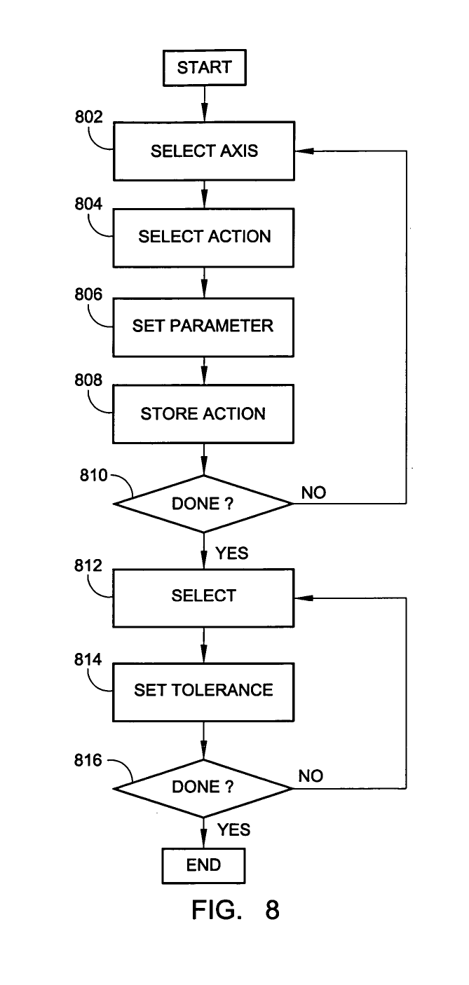

Referring next to FIG. 8, a flowchart is shown of the steps performed in a method of programming an actuator-based automated inspection routine with tolerance windows. By using control system program instructions (e.g., software) as provided according to several embodiments of the invention, an end user may program or configure the actuator based inspection system for the specific application without knowledge of programming. With the probe in a start position relative to a known component of good quality, an available axis of actuation is selected (802). Depending on the actuator device, one or more selectable axes may be available, e.g., one or more of x, y, z or rotation. Next, an action is selected (804). By way of example, the user selects to “jog”, “soft land” or “read value” in the selected axis. It is understood that many other actions may be selectable by the user. For example, the selected action is stored as a command code for the current step in the registers defining the motion profile (see FIG. 7).

Next, the user inputs the parameter/s corresponding to the action (806). Depending on the action selected, the parameter input will be different. For example, the programming instructions are configured to prompt the user to input the proper parameters. For example, if the user selects the jog coarse/fine action to jog the probe to a desired location on the selected axis, the user can input the velocity, delay time and whether or not the position is to be a datum point as parameters. If the action selected is to soft land about a given axis, the parameters prompted by the program and received as user inputs could include a force value, wait time and whether the soft land position is to be a datum point.

Next, the user stores the action and parameter/s (808). It is noted that the storing step may occur together with the individual steps 804 and 806. If the user is not done (810) with the motion profile, the user goes back to (802). In the event the user wishes to choose a new action on the currently selected axis, the user may proceed directly to (804). The user continues in this manner until a desired motion profile is stored.

Once the positional and parameter portions of the motion profile are stored (the user is done (810)), the user inputs tolerances for those parameters that the programming instructions are configured to request tolerance inputs. Generally, in one embodiment, the program is configured to request tolerance values whenever the user selects an action to read a position, read a force or soft land. In one implementation, the user is prompted to select a stored action having a corresponding measurement or reading (812) and inputs a tolerance (814) for that action, which is stored in memory. The user then selects the next stored action until there are no more stored actions to input tolerances (816). At this time, the motion profile is generally complete in that it includes data to define a complete series of steps and readings or measurements for the probe and provides a tolerance window for each reading or measurement that the user wishes to inspect.

It is noted that in an alternative embodiment, the tolerances may be entered at the time of inputting the parameters (806) and otherwise prior to storing an action (808), rather than after a motion profile is completed. For example, at time of storing, the user is prompted to input a tolerance window for the stored reference measurement.

Again, the software provides a programmable user interface that allows the user to program the motion profile including all tolerances without requiring that the software code itself be modified or specifically tailored to the application.

Referring next to FIG. 9, a portion of an actuator-based inspection system is shown for gauging/inspecting a component 902. An x, y, z actuator includes an actuator body 901 with a probe 904 extending therefrom. The probe 904 is moved to different locations (e.g., selectively moveable about the x, y and z axes), soft landed against various surfaces of the component 902 (which is stationary in this embodiment), encoder measurements are compared to known reference measurements to determine if they fall within an input tolerance window to determine pass/fail conditions for various dimensions. For example, the inspection system can determine if the inside and outside diameter of the component 902 is within tolerance levels at various locations.

In preferred embodiments, moving coil actuators, such as those manufactured and sold by Systems, Machines, Automation Components Corporation of Carlsbad, Calif. are used. Such moving coil actuators are known to be very effective for rapidly moving a work probe between predetermined positions on a path and to, thereafter, control the exertion of very small controlled forces by the probe on a workpiece.

Examples of several moving coil actuators are described in the following U.S. patents, all of which are incorporated herein by reference: U.S. Pat. No. 5,175,456, issued Dec. 29, 1992, to Neff et al., entitled Workpiece Transporter; U.S. Pat. No. 5,270,625, issued Dec. 14, 1993, to Neff, entitled Pneumatic/Electric Actuator; U.S. Pat. No. 5,310,064, issued May 10, 1994, to Neff et al., entitled Method and Apparatus For Sorting Component Parts Of An Assembly Process; U.S. Pat. No. 5,315,189, issued May 24, 1994, to Neff et al., entitled Actuator With Translational And Rotational Control; U.S. Pat. No. 5,317,222, issued May 31, 1994, to Neff et al., entitled Workpiece Transporter Device With Replaceable Grip; U.S. Pat. No. 5,446,323, issued Aug. 29, 1995, to Neff et al., entitled Actuator With Translational And Rotational Control; U.S. Pat. No. 5,685,214, issued Nov. 11, 1997, to Neff et al., entitled Actuator For Translational And Rotary Movement; U.S. Pat. No. 5,726,508, issued Mar. 10, 1998, to Neff et al., entitled Linear Voice Coil Retractor; U.S. Pat. No. 5,789,830, issued Aug. 4, 1998, to Portegies et al., entitled In-Line Rotational Drive; U.S. Pat. No. 5,798,582, issued Aug. 25, 1998, to Neff, entitled Linear Voice Actuator With Replaceable Magnetic Coil; U.S. Pat. No. 5,945,747, issued Aug. 31, 1999, to Neff et al., entitled Apparatus For Moving A Tool; U.S. Pat. No. 5,952,589, issued Sep. 14, 1999, to Leung et al., entitled Soft Landing Method For Probe Assembly; U.S. Pat. No. 6,016,039, issued Jan. 18, 2000, to Neff et al., entitled Control Processes For Linear Voice Coil Actuator; U.S. Pat. No. 6,043,573, issued Mar. 28, 2000, to Neff et al., entitled Linear Actuator With Burn-Out-Proof Coil; U.S. Pat. No. 6,076,875, issued Jun. 20, 2000, to Neff et al., entitled Gripper For Linear Voice Coil Actuator; U.S. Pat. No. 6,091,167, issued Jul. 18, 2000, to Vu et al., entitled Double Coil Actuator; U.S. Pat. No. 6,118,360, issued Sep. 12, 2000, to Neff, entitled Linear Actuator; and U.S. Pat. No. 6,518,682, issued Feb. 11, 2003, to Weaver et al., entitled System Monitor For A Linear/Rotary Actuator.

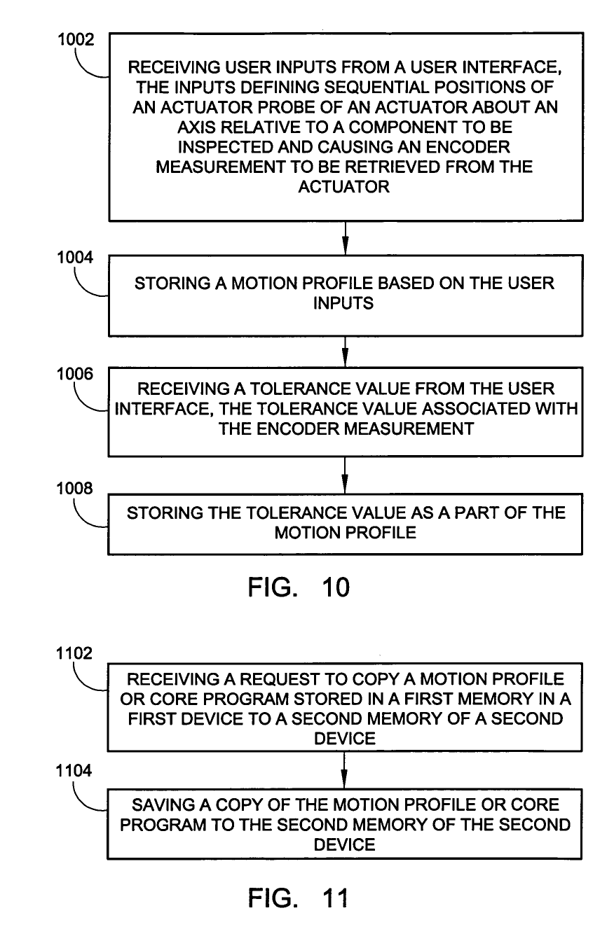

Referring next to FIG. 10, a flowchart is shown of the steps performed by control system programming instructions in accordance with one embodiment of the invention. The flowchart provides one embodiment of a method for programming an actuator controller. First, user inputs are received from a user interface, the inputs defining sequential positions of an actuator probe of an actuator about an axis relative to a component to be inspected and causing an encoder measurement to be retrieved from the actuator (Step 1002). For example, as described herein, the user enters input commands and parameters through the input device 106. The ability to do this is provided by the programming instructions of the controller 104 and/or the input device 106. Any of the variety of user inputs as described herein may be received as inputs. Next, a motion profile is stored based on the user inputs (Step 1004) and then, a tolerance value is received from the user interface, the tolerance value associated with the encoder measurement (Step 1006). And then, the tolerance value is stored as a part of the motion profile (Step 1008). As described herein, the program instructions allow for the user to finalize the programming of an actuator based inspection routine by inputting the information to create a motion profile that is needed by the program instructions to implement an inspection routine. Generally, the program instructions are unable to execute an inspection routine without a motion profile since they are specifically configured to generally apply to any component. The ability for the user to enter the tolerance value allows the program instructions to output pass/fail results for the inspected component.

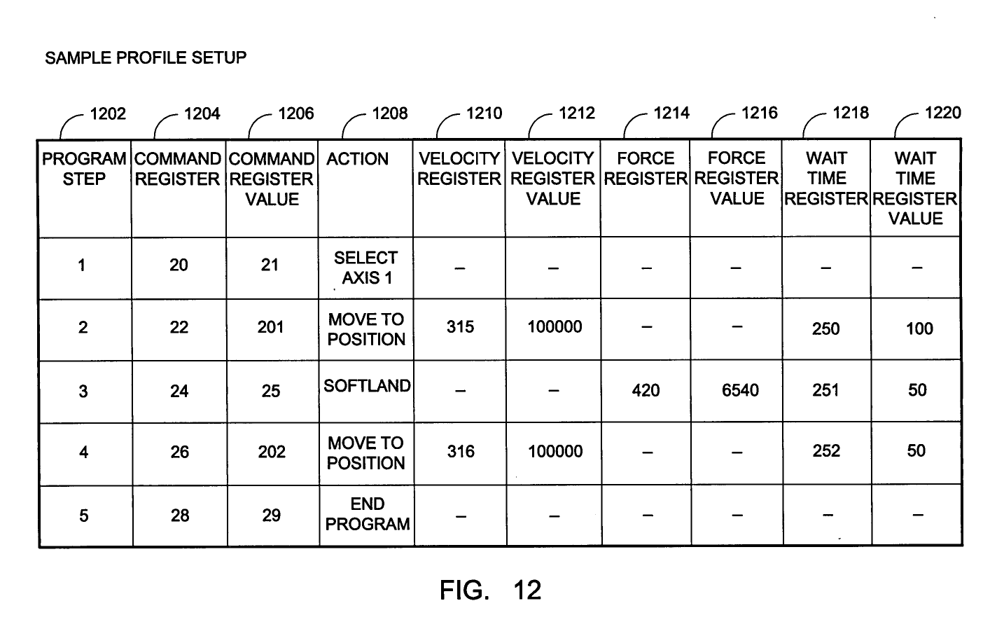

Referring next to FIG. 11, a flowchart is shown of the steps performed in accordance with one embodiment of the invention. This flowchart provides the minimal steps to transfer a stored motion profile or a stored set of program instructions (e.g., a core program). First, a request is received to copy a desired motion profile or a core program stored in a first memory in a first device to a second memory of a second device (Step 1102). Generally, the motion profile and core program are as described herein. The request is typically received by the program instructions operated the device that receives the request, such as the input device 106. In some embodiments, the request is for one of a plurality of motion profiles or one of a plurality of core programs stored in the memory. In response to the request, a copy of the motion profile or core program is saved to the second memory of the second device (Step 1104). For example, the selected motion profile or core program is transferred to the second device. The programming instructions provide for all of the control signals needed in order to transfer and save the motion profile or the core program. Depending on the device receiving the request and the location of the information to be copied, the first and second devices may sometimes be the user input device 106 or the controller 104. That is, a request may be received at either the input device 106 or the controller 104 for a transfer that is going in either direction. Furthermore, in one embodiment, when a copy of the selected item is saved to the other memory, a copy of the transferred item is retained in the transferring memory, whereas in other embodiments, the item is deleted from the transferring memory. As described herein, several embodiments allow a user to create and transfer motion profiles between multiple devices in an actuator control system. Likewise, an input device 106 may store several core programs, which may be transferred to different controllers 104.

It is understood that it is within the abilities of one of ordinary skill in the art to develop specific program instruction sets using a programming language of choice to produce a generic inspection program that allows a user to teach the program the final steps for a particular component to be inspected as described herein. While the invention herein disclosed has been described by means of specific embodiments and applications thereof, numerous modifications and variations could be made thereto by those skilled in the art without departing from the scope of the invention set forth in the claims.

1. An actuator control system comprising:
a controller adapted to be coupled to and control an actuator including a probe moveable by the actuator about an axis in response to control signals from the controller;
a user input device coupled to the controller and configured to receive inputs from a user to define an automated sequence of multiple locations of the probe and configured to cause an encoder measurement to be retrieved from the actuator; and
the user input device further configured to receive a tolerance value from the user corresponding to the encoder measurement.

2. The system of claim 1 further comprising:
program instructions executable by a processor configured to store a motion profile based on the inputs, the motion profile defining the automated sequence and configured to cause the encoder measurement to be retrieved from the actuator.

3. The system of claim 2 wherein the motion profile is specific to the dimensions of a component to be inspected.

4. The system of claim 2 wherein the program instructions are configured to provide a user interface to allow the user to input the inputs needed to generate the motion profile.

5. The system of claim 2 wherein the program instructions are configured to store the tolerance value as a part of the motion profile, and configured use the stored motion profile to execute an automated inspection of a component.

6. The system of claim 2 wherein the program instructions are configured to cause, in response to the inputs, a position of the probe to move in accordance with the inputs in order to allow visual verification of the inputs.

7. The system of claim 2 further comprising a memory, at least a portion of the program instructions stored in the memory, wherein the motion profile comprises a plurality of registers in the memory, each register storing a given action or parameter of the motion profile.

8. The system of claim 2 wherein at least a portion of the program instructions are stored in a memory within the controller.

9. The system of claim 2 wherein at least a portion of the program instructions are stored in a memory within the user input device.

10. The system of claim 1 wherein the controller is configured to execute program instructions to move the actuator probe and retrieve the encoder measurements as dictated by the motion profile in order to execute an inspection routine for a component.

11. The system of claim 10 wherein the program instructions of the controller are configured to output a pass/fail indication corresponding to the component and the tolerance value.

12. A method of programming an actuator controller for an automated inspection system comprising:
receiving user inputs from a user interface, the inputs defining sequential positions of an actuator probe of an actuator about an axis relative to a component to be inspected and causing an encoder measurement to be retrieved from the actuator;
storing a motion profile based on the user inputs;
receiving a tolerance value from the user interface, the tolerance value associated with the encoder measurement; and
storing the tolerance value as a part of the motion profile.

13. The method of claim 12 further comprising:
causing, in response to the user inputs, a position of the actuator probe to move in accordance with the user inputs in order to allow visual verification of the user inputs.

14. The method of claim 12 wherein the user inputs comprise one or more instructions selected from a group of instructions consisting of: actuator axis select; a soft land request along a given actuator axis; position change request along the given actuator axis; a parameter to define a velocity from a previous position of the actuator probe to a current position of the actuator probe; a parameter to define a delay time for the actuator probe at the current position; a request to set a position of the actuator probe as a reference point;
and a request for the actuator to take a reading.

15. A program for an automated actuator based inspection system comprising:
a memory; and
a set of program instructions executable by a processor stored on the memory, the set of program instructions configured to:
receive inputs from a user interface, the inputs defining sequential positions of an actuator probe of an actuator about an axis relative to a component to be inspected and causing an encoder measurement to be retrieved from the actuator;
store a motion profile based on the inputs;
receive a tolerance value from the user interface, the tolerance value associated with the encoder measurement; and
store the tolerance value as a part of the motion profile.

16. The program of claim 15 wherein the set of programmed instructions is configured to cause, in response to the inputs, a position of the actuator probe to move in accordance with the inputs in order to allow visual verification of the inputs.

17. The program of claim 15 wherein the set of program instructions is configured to provide a user interface to allow the user to input the inputs needed to generate the motion profile.

18. The program of claim 17 wherein the set of program instructions are unable to execute an actuator-based inspection routine for the component without access to the motion profile.

19. A control program for an actuator-based inspection system comprising:
a memory;
a motion profile stored in the memory, the motion profile including parameters defining sequential locations of a probe about at least one axis of an actuator relative to a component to be inspected, the motion profile including parameters defining encoder measurements to be retrieved from the actuator, and the motion profile including parameters defining a tolerance value corresponding to at least one encoder measurement; and
a set of program instructions executable by a processor stored on the memory, the set of program instructions configured to:
control positional locations of the probe about the at least one axis of the actuator relative to the component to be inspected in accordance with the motion profile;
cause the at least one encoder measurement to be retrieved from the actuator in accordance with the motion profile;
determine if the at least one encoder measurement is within the tolerance value;
wherein the set of program instructions is and unable to execute an inspection routine for the component to be inspected without access to the motion profile.

20. A method for use in an actuator control system comprising:
receiving a request to copy a motion profile stored in a first memory in a first device to a second memory of a second device, the motion profile including parameters defining sequential locations of a probe of an actuator about at least one axis of the actuator relative to a component to be inspected by the actuator control system and including parameters defining encoder measurements to be retrieved from the actuator, wherein the motion profile is to be used in cooperation with a set of program instructions adapted to operate the actuator in accordance with the motion profile;
saving a copy of the motion profile to the second memory of the second device.

21. The method of claim 20 wherein the first device comprises a user input device and the second device comprises an actuator controller.

22. The method of claim 20 wherein the first device comprises an actuator controller and the second device comprises a user input device.

23. The method of claim 20 wherein the receiving step comprises receiving a request to copy one of a plurality of motion profiles stored in the first memory, each motion profile configured for a particular component to be inspected.

24. A method for use in an actuator control system comprising:
receiving a request to copy a set of program instructions stored in a first memory in a first device to a second memory of a second device, the set of program instructions specific to a type of an actuator and wherein the set of program instructions is configured to be used in cooperation with a motion profile including parameters defining sequential locations of a probe of the actuator about at least one axis of the actuator relative to a component to be inspected by the actuator control system and including parameters defining encoder measurements to be retrieved from the actuator; and
saving a copy of the set of program instructions to the second memory of the second device.

25. The method of claim 24 wherein the first device comprises a user input device and the second device comprises an actuator controller.

26. The method of claim 24 wherein the first device comprises an actuator controller and the second device comprises a user input device.

27. The method of claim 24 wherein the receiving step comprises receiving a request to copy one of a plurality of sets of program instructions stored in the first memory, each set of program instructions specific to a different type of an actuator.
